(19) United States
(12) Patent Application Publication
(10) Pub. No.: US 2012/0156558 A1
(43) Pub. Date: Jun. 21, 2012

(54) ELECTRODE FOR LITHIUM ION SECONDARY BATTERY AND LITHIUM ION SECONDARY BATTERY

(76) Inventors: Yuko SAWAKI, Kyoto (JP); Mitsuhiro KISHIMI, Kyoto (JP)

(21) Appl. No.: 13/229,576

(22) Filed: Sep. 9, 2011

(30) Foreign Application Priority Data
Dec. 20, 2010 (JP) PCT/JP2010/072873
Mar. 15, 2011 (JP) PCT/JP2011/055989

(51) Int. Cl. H01M 4/13

(52) U.S. Cl. 429/209

(57) ABSTRACT

An electrode for a lithium ion secondary battery of the present invention includes an electrode material mixture layer containing oxide particles, active material particles capable of absorbing and desorbing Li, and a resin binder, wherein the oxide particles have an average particle size of primary particles of 1 to 20 nm, and have no peak or have a width at half height of the highest intensity peak of 1.0° or more within the range of 2θ=20 to 70° in a powder X-ray diffraction spectrum, and the ratio of the oxide particles is 0.1 to 10 mass % when the total of the active material particles and the oxide particles is taken as 100 mass %. Further, a lithium ion secondary battery of the present invention includes the above-described electrode for a lithium ion secondary battery of the present invention.

### BACKGROUND OF THE INVENTION

1. Field of the Invention

The present invention relates to a lithium ion secondary battery having favorable load characteristics and an electrode that can constitute the lithium ion secondary battery.

2. Description of Related Art

The development of lithium ion secondary batteries serving as batteries used for portable electronic devices, hybrid automobiles and the like advances rapidly. For such lithium ion secondary batteries, carbon materials are mainly used as the negative electrode active material and metal oxides, metal sulfides, various polymers and the like are used as the positive electrode active material. In particular, lithium composite oxides such as lithium cobaltate, lithium nickelate, and lithium manganate are commonly used recently as lithium ion secondary battery positive electrode active materials because they can provide high-energy density, high-voltage batteries.

In addition, with the recent improvement of the functions of devices for which batteries are used, it is desired, for example, to improve the load characteristics of batteries and it is conceivable to achieve this by increasing the lithium ion conductivity inside batteries when general-purpose active materials as described above are used. Examples of the main factors affecting the lithium ion conductivity in a lithium ion secondary battery include the following.

(1) The interface between the negative electrode active material and the non-aqueous electrolyte.

(2) The interface between the positive electrode active material and the non-aqueous electrolyte.

(3) The lithium ion diffusion in the non-aqueous electrolyte.

(4) The desolvation reaction energy of lithium ions.

(5) The lithium ion diffusion inside the active materials of the positive and negative electrodes.

Of these, it is known that in a single crystal structure, (5) the lithium ion diffusion inside the active materials takes place sufficiently fast and can accommodate discharge under high load. On the other hand, various studies are being carried out for improvement for (1) to (4).

For example, JP 2010-118179A proposes a technique to coat the surface of the positive electrode active material with a layer containing phosphorus to decrease the interface resistance between the positive electrode active material and the electrolyte, thus decreasing the internal resistance of the battery. Also, JP 2007-188861A proposes a technique to add 4-fluoro-1,3-dioxolane-2-one into the electrolyte as an additive to improve the lithium ion conductivity in the electrolyte and increase the ion conductivity of SEI (Solid Electrolyte Interface) film on the negative electrode surface.

Furthermore, JP 10-255842A, JP 2004-200176A and JP 2007-305545A propose techniques to include oxide particles in the active material layer (material mixture layer) of the positive electrode or the negative electrode, and JP 2007-305545A states that the lithium ion conductivity of an SEI film formed on the electrode surface can be improved by such a technique. It is believed that these methods have the potential to realize a decrease in the desolvation reaction energy through an improvement of the SEI film.

On the other hand, investigations to increase the capacity of lithium ion secondary batteries are also being made. For example, JP 2006-344390A proposes to enhance the utilization efficiency of the active material by increasing the charge voltage of the battery to a voltage higher than 4.2 V, which has been commonly used, thus increasing the battery capacity.

The present invention has been made in view of the foregoing circumstances, and provides a lithium ion secondary battery having favorable load characteristics, and an electrode that can constitute the lithium ion secondary battery.

### SUMMARY OF THE INVENTION

A lithium ion secondary battery electrode of the present invention is an electrode for a lithium ion secondary battery; the electrode comprising an electrode material mixture layer containing oxide particles, active material particles capable of absorbing and desorbing Li, and a resin binder, wherein the oxide particles have an average particle size of primary particles of 1 to 20 nm, and have no peak or have a width at half height of the highest intensity peak of 1.0° or more within the range of 2θ=20 to 70° in a powder X-ray diffraction spectrum, and the ratio of the oxide particles is 0.1 to 10 mass % when the total of the active material particles and the oxide particles is taken as 100 mass %.

Further, a lithium ion secondary battery of the present invention is a lithium ion secondary battery including a positive electrode, negative electrode, a non-aqueous electrolyte, and a separator, wherein at least one electrode selected from the positive electrode and the negative electrode is the above-described lithium ion secondary battery electrode of the present invention.

According to the present invention, it is possible to provide a lithium ion secondary battery having favorable load characteristics, and an electrode that can constitute the lithium ion secondary battery.

### BRIEF DESCRIPTION OF THE DRAWINGS

FIG. 1 is a powder X-ray diffraction spectrum of oxide particles used for a negative electrode of a lithium ion secondary battery according to Example 1.

FIG. 2 is a powder X-ray diffraction spectrum of oxide particles used for a negative electrode of a lithium ion secondary battery according to Example 2.

FIG. 3 is a powder X-ray diffraction spectrum of oxide particles used for a negative electrode of a lithium ion secondary battery according to Example 3.

FIG. 4 is a powder X-ray diffraction spectrum of oxide particles used for a negative electrode of a lithium ion secondary battery according to Comparative Example 3.

FIG. 5 is a vertical cross-sectional view schematically showing an example of a lithium ion secondary battery of the present invention.

### DETAILED DESCRIPTION OF THE INVENTION

A lithium ion secondary battery electrode (hereinafter, may also be simply referred to as “electrode”) of the present invention includes an electrode material mixture layer containing oxide particles, active material particles capable of absorbing and desorbing Li, and a resin binder, and has a structure in which the electrode material mixture layer is formed on one or both sides of a current collector, for example. An electrode of the present invention is used as at least one electrode selected from a positive electrode and a negative electrode of a lithium ion secondary battery.

The oxide particles contained in the electrode material mixture layer of the electrode of the present invention are fine and have low crystallinity.

With the use of the oxide particles in the electrode of the present invention, lithium ion diffusion polarization can be reduced by the influence of elements (metallic elements) contained in the oxide particles. Further, the surface properties of the active material of the electrode is changed by the oxide particles added, and therefore the interface resistance between the electrode (the active material contained therein) and the non-aqueous electrolyte can be reduced in a battery that uses the electrode. The load characteristics of the battery that uses the electrode of the present invention (the lithium ion secondary battery of the present invention) can be improved by these effects achieved by the oxide particles.

Further, with the electrode of the present invention, the non-aqueous electrolyte contained in the battery can be smoothly introduced into the electrode material mixture layer due to the surface polarity of the oxide particles. For this reason, even if the thickness of the electrode material mixture layer is increased, for example, the utilization efficiency of the active material of the electrode will not be reduced, and therefore it is possible to enhance the charge/discharge cycle characteristics of a battery that uses the electrode of the present invention, and also increase the capacity thereof even further.

The oxide particles have an average particle size of primary particles of 20 nm or less, preferably 10 nm or less. With such fine oxide particles, the above-described effect of increasing the battery load characteristics can be exerted favorably. Even if the size of the oxide particles is greater than 20 nm, a certain effect can be achieved, for example, for the reduction of the interface resistance between the electrode and the non-aqueous electrolyte when the oxide particles have low crystallinity. However, if the size of the oxide particles becomes too large, the electrical conduction in the electrode material mixture layer is impeded and the overall DC electrical resistance of the electrode material mixture layer is increased, leading to a failure to improve the load characteristics of a battery that uses this electrode. Accordingly, it is preferable that the oxide particles are as fine as possible.

However, if the size of the oxide particles is too small, it is difficult to produce the oxide particles and the handleability of the oxide particles is reduced. Accordingly, the oxide particles have an average particle size of primary particles of 1 nm or more, preferably 1.5 nm or more.

As used herein, the average particle size of primary particles of the oxide particles refers to an average value obtained by determining the particle diameter (if the particles are spherical) or the dimension of the longitudinal axis (if the particles have a shape other than a spherical shape) of 300 primary particles of the oxide particles observed with a transmission electron microscope (TEM), and dividing the total values of these particle sizes by the number (300) of the particles. However, if the size of the oxide particles is too small and is difficult to determine by the above-described method, then the average particle size of primary particles may be determined by small angle X-ray scattering.

Further, it is preferable that the oxide particles have no peak or have a width at half height of the highest intensity peak of 1.0° or more, preferably 1.5° or more within the range of 2θ=20 to 70° in a powder X-ray diffraction spectrum. With oxide particles having such low crystallinity, the above-described effect of improving the load characteristics of the battery can be exerted favorably. If the crystallinity of the oxide particles becomes high, the effect of reducing the interface resistance between the electrode and the non-aqueous electrolyte is reduced even with the use of particles of fine configurations, and therefore a significant enhancement of the battery load characteristics cannot be expected.

Furthermore, the specific surface area determined by nitrogen gas adsorption of the oxide particles is preferably 30 m²/g or more, more preferably 100 m²/g or more, and preferably 500 m²/g or less. When the specific surface area of the oxide particles has a value as mentioned above, the effect of enhancing the battery load characteristics is further increased. The reason seems to be as follows: Many dangling bonds remain, for example, on the top surface of the oxide particles having low crystallinity and a large structure, i.e., having such a specific surface area as those mentioned above, and thus these dangling bonds promote dissociation of lithium ions in the non-aqueous electrolyte, resulting in a further reduction in the lithium ion diffusion polarization.

As used herein, “specific surface area of the oxide particles” refers to a specific surface area of the surface and micropores of the oxide particles obtained by measuring the surface area and performing calculation by the BET method, which is a theory for multilayer adsorption. Specifically, it is a value obtained as the BET specific surface area by carrying out a measurement using an automatic specific surface area/pore size distribution measurement device (device model: BELSORP-mini) manufactured by BEL Japan, Inc., up to a relative pressure of 0.99 to a saturated vapor pressure. Further, the pressure at the start of measurement is used as the saturated vapor pressure, the actual measured value is used as the dead volume, and the drying conditions prior to measurement is for two hours at 80° C. in a nitrogen gas flow.

In terms of ease of providing an oxide with lower crystallinity, examples of the oxide constituting oxide particles include an oxide containing at least one element selected from the group consisting of Si, Zr, Al, Ce, Mg, Ti, Ba, and Sr. Note that the oxide constituting the oxide particles may be a hydrate of an oxide. Specific examples of such an oxide include SiOₓ (x=1.7 to 2.5), ZrO_{y} (y=1.8 to 2.2), ZrO₂.nH₂O (n=0.5 to 10), AlOOH, Al(OH)₃, CeO₂, MgO_{z} (z=0.8 to 1.2), MgOₐ.mH₂O (a=0.8 to 1.2, m=0.5 to 10), TiO_{b} (b=1.5 to 2), BaTiO₃, SrO, SrTiO₃, and Ba₂O₃. Further, the oxide may be an oxide substituted by another element, containing an element other than the above-described elements as long as the element can be substituted at the site of the metallic element without breaking the bonds of the oxide. Examples thereof include an oxide in which Zr in the above-mentioned ZrO_{y} is partly substituted with Y. It is also possible to use, for example, an oxide in which Ti in TiBaO₃ is partly substituted with Sr. As the oxide particles, for example, particles constituted by only one of these oxides may be used, or two or more of these oxides may be used in combination.

Any synthesis method may be adopted as the method for synthesizing the oxide particles, as long as the method can provide oxide particles with low crystallinity. However, it is technically difficult to achieve both a reduction in the crystallinity and a decrease in the size of primary particles, and it is preferable to adopt a synthesis method involving an oxidation treatment in an aqueous solution, such as a precipitation method or a hydrothermal treatment (hydrothermal synthesis) with a low heating temperature, in order to synthesize oxide particles having such a structure and configuration.

When the oxide particles are synthesized by a synthesis method involving the above-described oxidation treatment in an aqueous solution, the starting material needs to be dissolved in water, and it is therefore preferable to use a water-soluble salt containing an element constituting the oxide particles (an element other than oxygen). Examples of such a water-soluble salt include sulfates, nitrates, chlorides, and the like that contain an element constituting the oxide particles.

In the synthesis method involving an oxidation treatment in an aqueous solution, an aqueous solution of the above-described starting material (water-soluble salt) is neutralized by introducing thereto an aqueous alkaline solution such as ammonia water or an aqueous solution of a hydroxide of alkali metal such as sodium hydroxide, and a precipitate is formed by a coprecipitation method, followed by an oxidation treatment of the precipitate in an aqueous solution. As the oxidation treatment in an aqueous solution, it is possible to adopt, for example, a method in which oxygen, or a gas containing oxygen, such as air, is oxidized by bubbling while stirring, and a hydrothermal treatment method in which heat treatment is carried out under pressure. Although a method in which oxidation is performed by separately adding an oxidizing agent is also conceivable, care should be taken in selecting the oxidizing agent because the oxidizing agent may remain as an impurity. In the case of the precipitation method, the oxidation by bubbling may be carried out concurrently with the coprecipitation, and a suspension containing the produced precipitate is fully washed, and the precipitate is extracted from the solution by filtration or the like, followed by drying, to yield oxide particles.

In the case of the hydrothermal treatment method, a suspension (aqueous solution containing the above-described precipitate) obtained by the coprecipitation method is heated in a sealed container to heat-treat the suspension under pressure, then the suspension is fully washed before the precipitate is extracted by filtration, followed by drying, to yield oxide particles. In particular, it is preferable that the above-described SiOₓ, ZrO₂.nH₂O, AlOOH, Al(OH)₃, MgOₐ.mH₂O, and the like are subjected to a hydrothermal treatment to yield a gassy precipitate, then the precipitate is extracted, and subjected to a drying step, to yield oxide particles.

It is preferable that the pH of the suspension used in the hydrothermal treatment method is set to 4 to 11 by adjusting the amount of the aqueous alkaline solution added, and the pH may be selected from this range such that the desired oxide can be precipitated. For example, in the case of oxides from which a glassy precipitate can be obtained by the hydrothermal treatment as in the cases of the above-described SiOₓ, ZrO₂.nH₂O, AlOOH, Al(OH)₃, MgOₐ.mH₂O, it is preferable that the pH of the suspension is set in the range of a weakly acidic pH of 4 to 7 to a neutral pH. Further, in the case of synthesizing oxide particles by the above-described precipitation method, it is also preferable that the pH after introduction of the aqueous alkaline solution into the aqueous solution of the starting material is similar to the above-described pH of the suspension used in the hydrothermal treatment method.

The heating temperature in the hydrothermal treatment method is preferably 60° C. or more, and preferably 200° C. or less. Note that it is more preferable that a temperature that is sufficiently low such that oxide particles will not undergo excessive crystallization is selected as the heating temperature. Specifically, the heating temperature is more preferably 80° C. or more, and more preferably 150° C. or less, further preferably 120° C. or less.

Further, it is preferable that the heating time in the hydrothermal treatment method is one hour or more from the viewpoint of suppressing the formation of particles for which oxidative dehydrogenation has not been sufficiently performed. However, if the heating time is too long in the case of adopting the hydrothermal treatment method, the characteristics of the synthesized oxide particles will not be significantly affected, but the state of the oxide particles will no longer change after reaching a saturation reaction state that is determined by the pH of the suspension and the heating temperature. Therefore, the heating time in the hydrothermal treatment method is preferably 40 hours or less, more preferably 6 hours or less.

In the electrode of the present invention, from the viewpoint of favorably ensuring the above-described effect achieved by using the oxide particles, the ratio of the oxide particles is 0.1 mass % or more, preferably 0.5 mass % or more when the total of the oxide particles and the active material particles contained in the electrode material mixture layer is taken as 100 mass %. However, when the amount of the oxide particles contained in the electrode material mixture layer is too large, a large amount of insulating substances is present in the electrode material mixture layer, and thus the direct current resistance of the electrode increases, which instead results in a reduction in the load characteristics of a battery using this electrode. Therefore, the ratio of the oxide particles is 10 mass % or less, preferably 5 mass % or less, when the total of the oxide particles and the active material particles contained in the electrode material mixture layer is taken as 100 mass %.

When the electrode of the present invention is used as a negative electrode for a lithium ion secondary battery, active material particles used for a negative electrode of a conventionally known lithium ion secondary battery, or in other words, particles of an active material capable of absorbing and desorbing Li can be used as the active material particles. Specific examples of such active material particles include particles of graphites (natural graphite; artificial graphite obtained by graphitizing an easily graphitizable carbon such as a thermally decomposed carbon, mesophase carbon micro beads (MCMB) and carbon fibers at a temperature of 2800° C. or more; and the like), carbon material such as thermally decomposed carbons, cokes, glassy carbons, baked products of organic polymer compounds, MCMB, carbon fibers, and activated carbon; metals (Si, Sn, and the like) capable of forming an alloy with lithium, and materials containing these metals (alloys, oxides, and the like). When the electrode of the present invention is used as a negative electrode for a lithium ion secondary battery, only one type of these active material particles may be used, or two or more types of these may be used in combination.

Among the above-described negative electrode active materials, in particular, it is preferable to use material containing Si and O as its constituent elements (where the atomic ratio p of O to Si is 0.5≦p≦1.5. Hereinafter, the material is referred to as “SiOₚ”) in order to increase the battery capacity.

SiOₚ may include microcrystalline Si or amorphous Si. In this case, the atomic ratio of Si and O is the ratio including the microcrystalline or amorphous Si. That is, the SiOₚ may be a material having a structure in which Si (for example, microcrystalline Si) is dispersed in an amorphous SiO₂ matrix, and it is sufficient that the above-described atomic ratio p satisfies 0.5≦p≦1.5 where this amorphous SiO₂ and Si dispersed therein are combined. For example, in the case of a material having a structure in which Si is dispersed in the amorphous SiO₂ matrix and the molar ratio of SiO₂ and Si is 1:1, p=1, and therefore the structural formula is represented as SiO. In the case of a material having such a structure, for example, any peak resulting from the presence of Si (microcrystalline Si) may not be observed by an X-ray diffraction analysis, but an observation with a transmission electron microscope can confirm the presence of fine Si.

Since SiOₚ has low conductivity, the surface of SiOₚ may be coated with carbon, for example, and this allows a better conductive network to be formed in the negative electrode.

For example, low crystalline carbons, carbon nanotube, vapor grown carbon fibers, and the like can be used as the carbon for coating the surface of SiOₚ.

Note that if the surface of SiOₚ is coated with carbon by a method (vapor deposition (CVD) method) in which a hydrocarbon gas is heated in a vapor phase and carbon generated by the thermal decomposition of the hydrocarbon gas is deposited on the surface of the SiOₚ particles, the hydrocarbon gas is distributed throughout the SiOₚ particles, and thus a thin and uniform film containing a conductive material (carbon coating layer) can be formed on the surface or pores in the surface of the particles. Accordingly, it is possible to uniformly provide conductivity to the SiOₚ particles with a small amount of conductive material.

As the liquid source for the hydrocarbon gas used in the CVD method, toluene, benzene, xylene, mesitylene, and the like can be used. Toluene is particularly preferable because of the ease of handling. The hydrocarbon gas can be obtained by evaporating the liquid source (for example, by bubbling with a nitrogen gas). Further, it is possible to use a methane gas, an ethylene gas, an acetylene gas, and the like as the hydrocarbon gas.

The treatment temperature in the CVD method is preferably 600 to 1200° C., for example. Further, SiOₚ that is to be subjected to the CVD method is preferably a granulate (composite particles) granulated by a known method.

In the case of coating the surface of SiOₚ with carbon, the amount of carbon is preferably 5 parts by mass or more, preferably 10 parts by mass or more, and preferably 95 parts by mass or less, more preferably 90 parts by mass or less, with respect to 100 parts by mass of SiOₚ.

Note that SiOₚ undergoes a large volume change due to charging/discharging of the battery as with other high-capacity negative electrode material, and therefore it is preferable to use SiOₚ and graphite in combination as the negative electrode active material. This makes it possible to achieve an increased capacity with the use of SiOₚ, while suppressing expansion/contraction of the negative electrode due to charging/discharging of the battery, and thereby higher charge/discharge cycle characteristics can be maintained.

In the case of using SiOₚ and graphite in combination as the negative electrode active material, the ratio of SiOₚ with respect to the total amount of the negative electrode active material is preferably 0.5 mass % or more, from the viewpoint of favorably ensuring the capacity increasing effect with the use of SiOₚ. From the viewpoint of suppressing the expansion/contraction of the negative electrode due to SiOₚ, the ratio of SiOₚ is preferably 10 mass % or less.

When the electrode of the present invention is used as a positive electrode for a lithium ion secondary battery, active material particles used for a positive electrode of a conventionally known lithium ion secondary battery, or in other words, particles of an active material capable of absorbing and desorbing Li can be used as the active material particles. Specific examples of such active material particles include particles of a layer-structured lithium-containing transition metal oxide represented by Li_{1+c}M¹O₂ (−0.1<c<0.1, Co, Ni, Mn, Al, Mg, or the like), the spinel-structured lithium manganese oxide LiMn₂O₄ or part of its elements substituted with a different element, and an olivine-type compound represented by LiM²PO₄ (M²: Co, Ni, Mn, Fe, or the like). Examples of the layer-structured lithium-containing transition metal oxide include, in addition to LiCoO₂ and LiNi_{1-d}CO_{d-e}AlₑO₂(0.1≦d≦0.3, 0.01≦e≦0.2), oxides containing at least Co, Ni and Mn (LiMn_{1/3}Ni_{1/3}CO_{1/3}O₂, LiMn_{5/12}Ni_{5/12}Co_{1/6}O₂, LiMn_{3/5}Ni_{1/5} Co_{1/5}O₂, and the like). When the electrode of the present invention is used as a positive electrode for a lithium ion secondary battery, only one type of these active material particles may be used, or two or more types of them may be used in combination.

Note that in the above-described active material particles with the electrode of the present invention being used as a negative electrode for a lithium ion secondary battery and the active material particles with the electrode of the present invention being used as a positive electrode for a lithium ion secondary battery, the average particle size of primary particles measured by the same method as that for the oxide particles is preferably 50 nm or more, and preferably 500 μm or less, more preferably 10 μm or less.

As the resin binder for the electrode material mixture layer of the electrode of the present invention, it is possible to use the same resin binders used in the positive electrode material mixture layer for a positive electrode for a conventionally known lithium ion secondary battery, and the negative electrode material mixture layer for a negative electrode for such a lithium ion secondary battery. Specifically, preferable examples thereof include polyvinylidene fluoride (PVDF), polytetrafluoroethylene (PTFE), styrene butadiene rubber (SBR), and carboxymethyl cellulose (CMC).

Further, a conductivity enhancing agent can also be contained as needed in the electrode material mixture layer for the electrode of the present invention Specific examples of the conductivity enhancing agent include graphites such as natural graphite (e.g., flake graphite) and artificial graphite; carbon blacks such as acetylene black, Ketjen black, channel black, furnace black, lamp black, and thermal black; and carbon fibers.

When the electrode of the present invention is used as a negative electrode for a lithium ion secondary battery, it is preferable that the composition of the components in the electrode material mixture layer (negative electrode material mixture layer) is made up of 85 to 99 mass % of the active material particles and 1.0 to 10 mass % of the resin binder, for example. Further, in the case of using the conductivity enhancing agent, the amount of the conductivity enhancing agent in the electrode material mixture layer is preferably 0.5 to 10 mass %. Also, the thickness of the electrode material mixture layer (negative electrode material mixture layer) (in the case of forming the electrode material mixture layer one or both sides of the current collector, the thickness per side of the current collector) is preferably 30 to 150 μm.

When the electrode of the present invention is used as a negative electrode for a lithium ion secondary battery including a current collector, it is possible to use foil, punched metal, mesh, expanded metal, and the like made of copper or nickel as the current collector. Ordinarily, copper foil is used. The thickness of the current collector is preferably 5 to 30 μm.

When the electrode of the present invention is used as a positive electrode for lithium ion secondary battery, it is preferable that the composition of the components in the electrode material mixture layer (positive electrode material mixture layer) is made up of 75 to 95 mass % of the active material particles, 2 to 15 mass % of the resin binder, and 2 to 15 mass % of the conductivity enhancing agent, for example. Also, the thickness of the electrode material mixture layer (positive electrode material mixture layer) (in the case of forming the electrode material mixture layer one or both sides of the current collector, the thickness per side of the current collector) is preferably 30 to 180 μm.

When the electrode of the present invention is used as a positive electrode for a lithium ion secondary battery including a current collector, it is possible to use foil, punched metal, mesh, expanded metal, and the like made of aluminum as the current collector. Ordinarily, aluminum foil is used. The thickness of the current collector is preferably 10 to 30 μm.

The electrode of the present invention can be produced, for example, through a process involving applying, to one or both sidles of the current collector, an electrode material mixture-containing composition (paste, slurry, or the like) prepared by dispersing, in a solvent, including, for example, an organic solvent such as N-methyl-2-pyrrolidone (NMP) and water, an electrode material mixture containing the oxide particles, the active material particles, and the resin binder, and optionally the conductivity enhancing agent; drying; and optionally performing pressing.

Note that from the viewpoint of more favorably ensuring the above-described effect by the oxide particles, it is preferable that the aggregation of the oxide particles is suppressed in the electrode material mixture layer. Specifically, the dispersed particle size of the oxide particles in the electrode material mixture layer is preferably 300 nm or less. The dispersed particle size of the oxide particles as used herein is a value obtained by observing the cross section of the electrode with a scanning electron microscope (SEM) and measuring the diameter of the largest particle among 100 oxide particles (including oxide particles dispersed in the state of primary particles, and oxide particles that are aggregated and dispersed in the state of secondary particles).

Thus, in order to suppress the aggregation of the oxide particles in the electrode material mixture layer, it is preferable that the electrode material mixture layer is formed using electrode material mixture-containing composition prepared by the following method. First, the oxide particles are dispersed in the same solvent as that used for the electrode material mixture-containing composition, to prepare an oxide particle dispersion. Preferably, no organic matter such as a resin binder or a dispersing agent is contained in this oxide particle dispersion.

The oxide particle dispersion can be prepared by using a known disperser suitable for preparation of a nanoparticle dispersion, such as a ball mill, a nano mill, a pico mill, a paint shaker, or a dissolver.

The dispersing conditions for the oxide particle dispersion and the concentration of the oxide particles (solid content concentration) in the oxide particle dispersion may be selected such that the dispersed particle size of the oxide particles is 300 nm or less in an electrode material mixture layer that is formed later. Specifically, it is preferable that the solid content concentration of the oxide particle dispersion is, for example, 5 to 50 mass %, in view of the later preparation of the electrode material mixture-containing composition, dispersion stability, handleability, and the like. For example, in the case of using zirconia beads to prepare the oxide particle dispersion having the above-described solid content concentration by using a paint shaker, it is preferable that the dispersing condition for the oxide particle dispersion is such that the dispersing time is about 5 minutes to 2 hours.

The active material particles and the resin binder, and optionally the conductivity enhancing agent and the solvent are added to the oxide particle dispersion prepared as described above and all are mixed, to prepare an electrode material mixture-containing composition. Note that the active material particles and the resin binder, and the conductivity enhancing agent may be previously dispersed in a solvent to prepare a dispersion liquid (the resin binder may be dissolved in the solvent), and the dispersion liquid and the oxide particle dispersion are mixed to prepare an electrode material mixture-containing composition.

When mixing the oxide particle dispersion, the active material particles, the resin binder, the conductivity enhancing agent, and the like, it is possible to use a disperser that uses a dispersion medium such as zirconia beads. However, there is the possibility that the dispersion medium may cause damage to the active material particles, and therefore it is more preferable to use a medialess disperser. Examples of the medialess disperser include general-purpose dispersers such as a hybrid mixer, a nanomizer, and a jet mill.

For example, a lead portion for connecting to a terminal in the battery by an ordinary method can be formed in an electrode whose electrode material mixture layer is formed by using the electrode material mixture-containing composition prepared as described above to which pressing is further performed as needed.

The lithium ion secondary battery (hereinafter, may also be simply referred to as “battery”) of the present invention includes a positive electrode, a negative electrode, a non-aqueous electrolyte, and a separator. At least one of the positive electrode and the negative electrode may be the electrode for a lithium ion secondary battery of the present invention. There is no particular limitation on the other configuration and structure, and it is possible to use various configurations and structures that are adopted in conventionally known lithium ion secondary batteries.

In the battery of the present invention, only one of the positive electrode and the negative electrode may be the electrode of the present invention, or both the positive electrode and the negative electrode may be the electrode of the present invention. When only the negative electrode of the battery of the present invention is the electrode of the present invention, a positive electrode having the same configuration as the electrode of the present invention (positive electrode) except for not containing the oxide particles can be used as the positive electrode. When only the positive electrode of the battery of the present invention is the electrode of the present invention, a negative electrode having the same configuration as the electrode of the present invention (negative electrode) except for not containing the oxide particles can be used as the negative electrode.

It is preferable that the separator of the battery of the present invention has the property (or in other words, a shutdown function) of closing the pores at a temperature of 80° C. or more (more preferably 100° C. or more) and 170° C. or less (more preferably 150° C. or less). It is possible to use a separator used for commonly used lithium ion secondary batteries and the like, including, for example, a microporous film made of polyolefin such as polyethylene (PE) or polypropylene (PP). The microporous film constituting the separator may be a microporous film using only PE or only PP, for example, or may be a laminate of a PE microporous film and a PP microporous film. The thickness of the separator is preferably 10 to 30 μm, for example.

The above positive electrode and the above negative electrode and the above separator can be used for the battery of the present invention in the form of a laminated electrode assembly obtained by placing a positive electrode and a negative electrode on one another with a separator disposed therebetween, or in the form of a wound electrode assembly that is formed by further winding the laminated electrode assembly in a spiral fashion.

As the non-aqueous electrolyte of the battery of the present invention, it is possible to use a non-aqueous electrolyte prepared, for example, by dissolving at least one lithium salt selected, for example, from LiClO₄, LiPF₆, LiBF₄, LiAsF₆, LiSbF₆, LiCF₃SO₃, LiCF₃CO₂, Li₂C₂F₄(SO₃)₂, LiN(CF₃SO₂)₂, LiC(CF₃SO₂)₃, and LiCₙF₂ₙ₊₁SO₃ (2≦n≦7), LiN(R_{f}OSO₂)₂ (where R_{f} is a fluoroalkyl group) in an organic solvent such as dimethyl carbonate, diethyl carbonate, methyl ethyl carbonate, methyl propionate, ethylene carbonate, propylene carbonate, butylene carbonate, γ-butyrolactone, ethylene glycol sulfite, 1,2-dimethoxyethane, 1,3-dioxolane, tetrahydrofuran, 2-methyl-tetrahydrofuran, or diethyl ether. The concentration of the lithium salt in the non-aqueous electrolyte is preferably 0.5 to 1.5 mol/l, particularly preferably 0.9 to 1.25 mol/l. For the purpose of improving characteristics such as safety, charge/discharge cycle characteristics, high temperature storage characteristics, an additive such as vinylene carbonate, 1,3-propanesultone, diphenyl disulfide, cyclohexyl benzene, biphenyl, fluorobenzene, or t-butyl benzene can be added to the electrolytes as appropriate.

Further, a known gelling agent such as a polymer may be added to the non-aqueous electrolyte, and the non-aqueous electrolyte may be used in the form of a gel (gel electrolyte).

In terms of the form, the lithium ion secondary battery of present invention can be, for example, a cylindrical (e.g., rectangular cylindrical or circular cylindrical) battery that uses a steel can or an aluminum can as the outer case can, or may be a soft package battery using a laminated film having a metal vapor-deposited thereon as an outer case member.

The lithium ion secondary battery of the present invention can be installed in a conventional general-purpose charging apparatus, including, for example, a constant current-constant voltage charging apparatus and a pulsed charging apparatus. In this case, the end-of-charge voltage of the battery can be set within a specified range by setting the end-of-charge voltage of the charging apparatus within the range from 4.3 to 4.6 V.

An increased battery capacity can be achieved, for example, by increasing the end-of-charge voltage to a value higher than the conventional value (4.2 V), or increasing the thickness of the electrode material mixture layer.

In the case of increasing the charge voltage of the battery, however, a non-uniform charge/discharge reaction in the electrode causes variations in the utilization efficiency of the active material, and therefore problems such as a reduction in the charge/discharge cycle characteristics of the battery tend to occur. However, with the battery of the present invention including the electrode of the present invention containing the oxide particles, the charge/discharge reaction in the electrode can be made uniform by the effect of the oxide particles, and therefore the overall utilization efficiency of the active material can be increased even if the end-of-charge voltage of the battery is increased to the range from 4.3 to 4.6 V. Thus, according to the present invention, it is possible to achieve a lithium ion secondary battery that has favorable load characteristics and is highly reliable, while realizing an increased capacity.

Further, as described above, increasing the thickness of the electrode material mixture layer of the electrode also may lead to a reduction in the overall utilization efficiency of the active material, resulting in a reduction, for example, in the load characteristics of the battery. However, with the battery of the present invention including the electrode of the present invention containing the oxide particles, the surface polarity of the oxide particles allows the non-aqueous electrolyte to be smoothly introduced into the electrode material mixture layer, making it possible to increase the overall utilization efficiency of the active material. Therefore, according to the present invention, it is possible to achieve a lithium ion secondary battery that has favorable load characteristics and is highly reliable even if the capacity has been increased by increasing the thickness of the electrode material mixture layer.

The lithium ion secondary battery of the present invention has excellent load characteristics and excellent charge/discharge cycle characteristics, and can be applied to uses including those that require such characteristics, and various uses to which conventionally known lithium ion secondary batteries are applied.

Hereinafter, the present invention will be described in detail by way of examples. However, the following examples are not intended to limit the present invention.

### Examples of Lithium Ion Secondary Battery (Test Cell) Including Laminated Film Outer Case Member

### Example 1

### Synthesis of Oxide Particles

First, zirconyl chloride octahydrate was dissolved in water to prepare an aqueous zirconium salt solution with a concentration of 8 mass %. Next, the aqueous zirconium salt solution was added dropwise to an aqueous ammonia solution with a concentration of 1.4 mass % while stirring, to generate a precipitate containing hydrated zirconium oxide particles. The suspension containing this precipitate was aged at room temperature for 21 hours.

Subsequently, the suspension was introduced into an autoclave, heated to 100° C. over one hour, then was subjected to a hydrothermal treatment at 100° C. for 7 hours, and cooled to room temperature over 10 hours, followed by aging at room temperature for 36 hours.

Next, the precipitate after the hydrothermal treatment was washed using an ultrasonic washer in order to remove any unreacted substance and impurities, and then filtration was performed to collect the precipitate, which was dried in air at 60° C. for 6 hours. The dried precipitate was lightly cracked in a mortar to yield hydrated zirconium oxide particles (ZrO₂.5H₂O).

The amount of water of hydration of the hydrated zirconium oxide particles was determined as the amount of water of hydration n of the particles of hydrated zirconium oxide represented by the general formula ZrO₂.nH₂O by performing thermogravimetry-differential thermal analysis (TG/DTA) using a differential thermal balance (device model: TG-DTA-2000S) manufactured by Rigaku Corporation for the hydrated zirconium oxide particles after one hour has elapsed since the completion of drying.

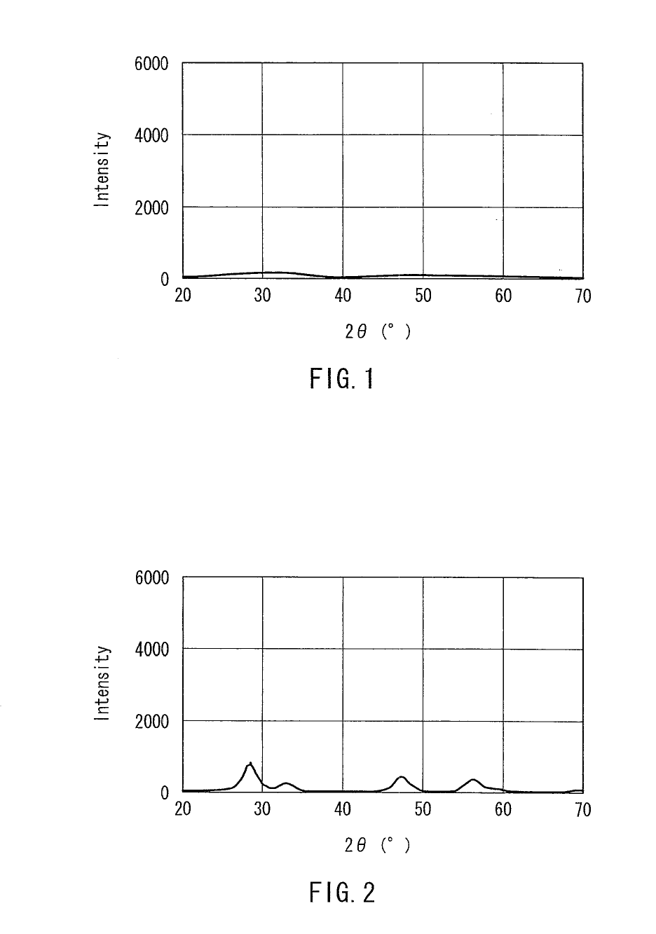

FIG. 1 shows the powder X-ray diffraction spectrum of the hydrated zirconium oxide particles. As can be clearly seen from FIG. 1, for the hydrated zirconium oxide particles, no clear diffraction line peak was observed within the rage of 2θ=20 to 70° in the powder X-ray diffraction spectrum, demonstrating an amorphous structure in which no crystallinity can be ascertained.

Further, the average particle size of primary particles determined from a TEM photograph of the hydrated zirconium oxide particles by the above-described method was 2.1 nm, and the specific surface area (BET specific surface area) determined by nitrogen gas adsorption was 433 m²/g.

### Preparation of Negative Electrode Material Mixture-Containing Composition

The hydrated zirconium oxide particles were added to water in an amount to give 20 mass %, and mixed in a paint shaker for one hour using zirconia beads with a diameter of 0.3 mm, to prepare an aqueous dispersion of the hydrated zirconium oxide particles. As a result of the SEM observation of 100 pieces of the hydrated zirconium oxide particles in the aqueous dispersion, the largest diameter of the dispersed particles was 116 nm.

98 parts by mass of flake graphite (manufactured by Hitachi Chemical Co., Ltd., average particle size of primary particles: about 450 μm) serving as the negative electrode active material, 1 part by mass of acetylene black serving as the conductivity enhancing agent, and 1 part by mass of CMC serving as the resin binder were dispersed in 100 parts by mass of water to prepare a dispersion. 2.5 parts by mass of the aqueous dispersion of the hydrated zirconium oxide particles were added to 100 parts by mass of this dispersion, and mixed in a paint shaker for about 15 minutes without using any dispersing beads, to prepare a negative electrode material mixture-containing composition containing the hydrated zirconium oxide particles in an amount of 1 mass % with respect to 100 mass % of the total of the flake graphite and the hydrated zirconium oxide particles.

### Production of Lithium Ion Secondary Battery (Test Cell)

The negative electrode material mixture-containing composition was applied to one side of an 8 μm-thick copper foil serving as the current collector by using an applicator, dried, pressed, and then cut to have dimensions of 35×35 mm, thus producing a negative electrode. The negative electrode material mixture layer of the obtained negative electrode has a thickness of 63 μm. Further, the dispersed particle size of the hydrated zirconium oxide particles in the negative electrode material mixture layer determined by the above-described method was 134 nm.

Further, 93 parts by mass of spinel manganese (LiMn₂O₄, average particle size of primary particles: about 15 μm) serving as the positive electrode active material, 3.5 parts by mass of acetylene black serving as the conductivity enhancing agent, 3.2 parts by mass of PVDF serving as the resin binder, and 0.3 parts by mass of polyvinyl pyrrolidone were dispersed in NMP to prepare a positive electrode material mixture-containing composition, which was then applied to one side of a 15 μm-thick aluminum foil serving as the current collector by using an applicator such that the amount of the spinel manganese serving as the active material was 20 mg/cm², dried, pressed, and then cut to have dimensions of 30×30 mm, thus producing a positive electrode. The positive electrode material mixture layer of the obtained positive electrode had a thickness of 80 μm.

The above positive electrode and the above negative electrode were laminated with a separator (a 16 μm-thick PE microporous film) disposed therebetween, then inserted into a laminated film outer case member, into which a non-aqueous electrolyte (a solution in which LiPF₆ was dissolved at a concentration of 1.2 M in a mixed solvent of ethylene carbonate and diethyl carbonate at a volume ratio of 3:7) was injected, and then the laminated film outer case member was sealed, thus producing a test cell.

### Example 2

Cerium chloride heptahydrate was dissolved in water to prepare an aqueous cerium chloride solution with a concentration of 3.0 mass %. Using an aqueous sodium hydroxide solution having the same number of bases as that of the aqueous cerium chloride solution as an alkaline solution, the aqueous cerium chloride solution was added dropwise while stirring the alkaline solution at room temperature, to precipitate the hydroxide, and then the pH of the suspension was adjusted to 8. Thereafter, the suspension was aged at room temperature for about 12 hours, and then the pH was adjusted to 8 again. After performing a hydrothermal treatment at 180° C. for 5 hours in the same manner as in Example 1 and washing in the same manner as in Example 1, filtration and drying were performed, thus yielding cerium chloride (CeO₂) particles.

As the result of measuring the powder X-ray diffraction spectrum for the cerium chloride particles, the particles had relatively broad peaks and had a width at half height of the highest intensity peak of 1.75° within the range of 2θ=20 to 70°. FIG. 2 shows the powder X-ray diffraction spectrum of the cerium chloride particles.

Further, the average particle size of primary particles determined from a TEM photograph of the cerium chloride particles by the above-described method was 2.2 nm, and the specific surface area (BET specific surface area) determined by nitrogen gas adsorption was 220 m²/g.

A negative electrode was produced in the same manner as in Example 1 except that the cerium chloride particles were used in place of the hydrated zirconium oxide particles, and a test cell (lithium ion secondary battery) was produced in the same manner as in Example 1 except that this negative electrode was used.

Further, the dispersed particle size of the cerium chloride particles in the negative electrode material mixture layer measured by the above-described method was 76 nm.

### Example 3

Aluminum chloride was dissolved in water to prepare an aqueous aluminum chloride solution with a concentration of 4.0 mass %. Using an aqueous sodium hydroxide solution having the same number of bases as that of the aqueous aluminum chloride solution, the aqueous aluminum chloride solution was added dropwise while stirring the alkaline solution at room temperature, to precipitate the hydroxide, and then the pH of the suspension was adjusted to 5. Then, after performing a hydrothermal treatment at 90° C. for 36 hours in the same manner as in Example 1 without aging the suspension, to yield an aluminum gel and washing in the same manner as in Example 1, filtration and drying were performed, thus yielding aluminum hydroxide [Al(OH)₃] particles.

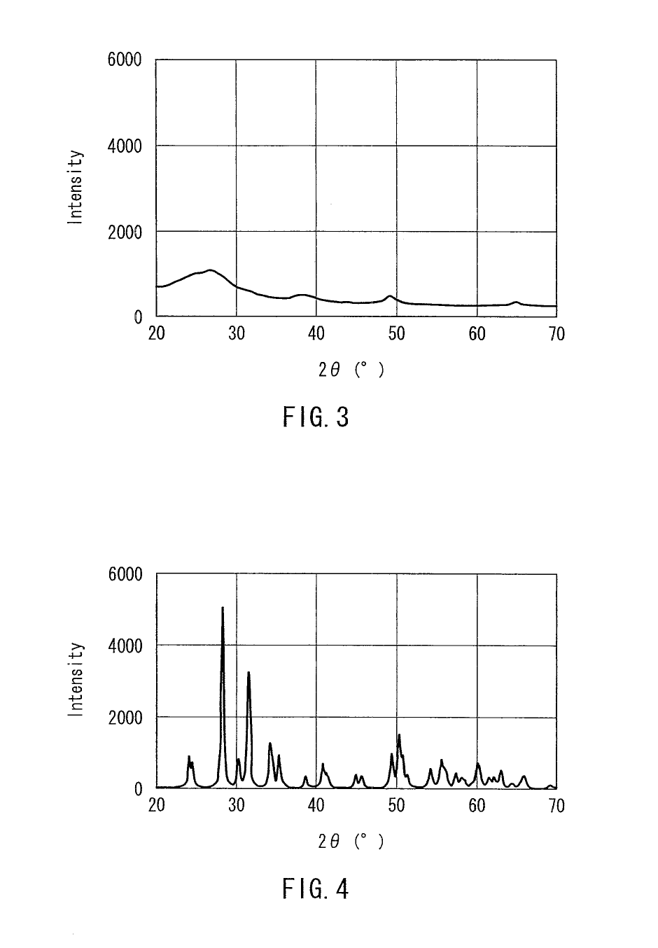

As the result of measuring the powder X-ray diffraction spectrum for the aluminum hydroxide particles, the particles had very broad peaks and had a width at half height of the highest intensity peak of about 9.5° within the range of 2θ=20 to 70°. Although peaks indicating that some sort of structure were observed, the structure was found to be that of low crystalline substances similar to an amorphous structure in which no crystallinity can be identified. FIG. 3 shows the powder X-ray diffraction spectrum of the aluminum hydroxide particles.

Further, the average particle size of primary particles determined from a TEM photograph of the aluminum hydroxide particles by the above-described method was 8.2 nm, and the specific surface area (BET specific surface area) determined by the nitrogen gas adsorption was 85 m²/g.

A negative electrode was produced in the same manner as in Example 1 except that the aluminum hydroxide particles were used in place of the hydrated zirconium oxide particles, and a test cell (lithium ion secondary battery) was produced in the same manner as in Example 1 except that this negative electrode was used.

Further, the dispersed particle size of the aluminum hydroxide particles in the negative electrode material mixture layer measured by the above-described method was 231 nm.

### Comparative Example 1

A negative electrode was produced in the same manner as in Example 1 except that the hydrated zirconium oxide particles were not used, and a test cell (lithium ion secondary battery) was produced in the same manner as in Example 1 except that this negative electrode was used.

### Comparative Example 2

A negative electrode material mixture-containing composition containing the hydrated zirconium oxide particles in an amount of 15 mass % with respect to 100 mass % of the total of flake graphite and the hydrated zirconium oxide particles was prepared in the same manner as in Example 1 except that 43 parts by mass of an aqueous dispersion of the hydrated zirconium oxide particles were added to 100 parts by mass of a dispersion containing flake graphite and the like.

A negative electrode was produced in the same manner as in Example 1 except that the negative electrode material mixture-containing composition was used, and a test cell (lithium ion secondary battery) was produced in the same manner as in Example 1 except that this negative electrode was used.

Further, the dispersed particle size of the hydrated zirconium oxide particles in the negative electrode material mixture layer measured by the above-described method was 154 nm.

### Comparative Example 3

Hydrated zirconium oxide particles synthesized in the same manner as in Example 1 were heat-treated in air at 600° C. for 2 hours to yield zirconium oxide particles. As the result of measuring the powder X-ray diffraction spectrum for the zirconium oxide particles, peaks indicating a mixture of monoclinic and tetragonal zirconium oxides were observed within the range of 2θ=20 to 70°. Among them, the width at half height of the highest intensity peak was 0.7°. FIG. 4 shows the powder X-ray diffraction spectrum of the zirconium oxide particles.

Further, the average particle size of primary particles determined from a TEM photograph of the zirconium oxide particles by the above-described method was 25 nm, and the specific surface area (BET specific surface area) determined by the nitrogen gas adsorption was 23 m²/g.

A negative electrode was produced in the same manner as in Example 1 except that the zirconium oxide particles were used in place of the hydrated zirconium oxide particles, and a test cell (lithium ion secondary battery) was produced in the same manner as in Example 1 except that the negative electrode was used.

Further, the dispersed particle size of the zirconium oxide particles in the negative electrode material mixture layer measured by the above-described method was 93 nm.

### Comparative Example 4

Aluminum hydroxide particles synthesized in the same manner as in Example 3 were heat-treated in air at 1200° C. for 4 hours to yield aluminum oxide particles. As the result of measuring the powder X-ray diffraction spectrum for the aluminum oxide particles, peaks indicating α-alumina were observed within the range of 2θ=20 to 70°. Among them, the width at half height of the highest intensity peak was 0.28°.

Further, the average particle size of primary particles determined from a TEM photograph of the aluminum oxide particles by the above-described method was 274 nm, and the specific surface area (BET specific surface area) determined by the nitrogen gas adsorption was 9.6 m²/g.

A negative electrode was produced in the same manner as in Example 1 except that the aluminum oxide particles were used in place of the hydrated zirconium oxide particles, and a test cell (lithium ion secondary battery) was produced in the same manner as in Example 1 except that the negative electrode was used.

Further, the dispersed particle size of the aluminum oxide particles in the negative electrode material mixture layer measured by the above-described method was 382 nm.

The load characteristics and the charge/discharge cycle characteristics of the test cells of Examples 1 to 3 and Comparative Examples 1 to 4 were evaluated by the following method.

### Load Characteristics

The test cells of Examples 1 to 3 and Comparative Examples 1 to 4 was subjected to constant current charging with a current value of 1 C until the voltage reached 4.2 V. Subsequently, the test cells were subjected to constant voltage charging with 4.2 V. Note that the total charging time of the constant current charging and the constant voltage charging was 2 hours. Then, each test cell was discharged with a current value of 0.2 C until the voltage reached 2.5 V to determine the 0.2 C discharge capacity.

Further, each test cell was charged under the same conditions as described above. Thereafter, each test cell was discharged with a current value of 5 C until the voltage reached 2.5 V to determine the 5 C discharge capacity. Then, the value obtained by dividing the 5 C discharge capacity by the 0.2 C discharge capacity of each test cell was expressed in percentage to determine the capacity retention rate. It can be said that the larger the value of the capacity retention rate, the better the load characteristics of the test cell.

### Charge/Discharge Cycle Characteristics

The test cells of Examples 1 to 3 and Comparative Examples 1 to 4 were subjected to constant current charging with a current value of 1 C until the voltage reached 4.2 V. Subsequently, the test cells were subjected to constant voltage charging with 4.2 V. Note that the total charging time of the constant current charging and the constant voltage charging was 2 hours. Then, each test cell was discharged with a current value of 1 C until the voltage reached 2.5 V. 100 charging/discharging cycles were performed in which a series of operation of the above-described constant current charging-constant voltage charging-discharging was taken as one cycle. Then, the value obtained by dividing the discharge capacity at the 100th cycle by the discharge capacity at the 10th cycle was expressed in percentage to determine the capacity retention rate. It can be said that the larger the value of the capacity retention rate, the better the charge/discharge cycle characteristics of the test cell.

Tables 1 and 2 show the configurations of the oxide particles used for the test cells of Examples 1 to 3 and Comparative Examples 1 to 4, and Table 3 shows the results of the above-described evaluations.

TABLE 1

| | Oxide particles | | | |
|---|---|---|---|---|
| | | Width | Average particle | |
| | | at half | size of primary | Specific |
| | | height | particles | surface area |
| | Type | (°) | (nm) | (m²/g) |
| Example 1 | ZrO₂•5H₂O | — | 2.1 | 433 |
| Example 2 | CeO₂ | 1.75 | 2.2 | 220 |
| Example 3 | Al(OH)₃ | 9.5 | 8.2 | 85 |
| Com. Ex. 1 | — | — | — | — |
| Com. Ex. 2 | ZrO₂•5H₂O | — | 2.1 | 433 |
| Com. Ex. 3 | ZrO₂ | 0.7 | 25 | 23 |
| Com. Ex. 4 | Al₂O₃ | 0.28 | 274 | 9.6 |

In Table 1, “Width at half height” means the width at half height of the highest intensity peak present within the range of 2θ=20 to 70° in the powder X-ray diffraction spectrum of the oxide particles.

TABLE 2

Oxide particles

| | | Dispersed particle size |
|---|---|---|
| | | in negative electrode |
| | Ratio | material mixture layer |
| | (mass %) | (nm) |
| Example 1 | 1 | 134 |
| Example 2 | 1 | 76 |
| Example 3 | 1 | 231 |
| Com. Ex. 1 | 0 | — |
| Com. Ex. 2 | 15 | 154 |
| Com. Ex. 3 | 1 | 93 |
| Com. Ex. 4 | 1 | 382 |

In Table 2, “Ratio” means the ratio of the oxide particles with respect to 100 mass % of the total of the active material particles and the oxide particles.

TABLE 3

| | Load | |
|---|---|---|
| | characteristics | Charge/discharge cycle |
| | Capacity | characteristics |
| | retention rate | Capacity retention rate |
| | (%) | (%) |
| Example 1 | 61 | 96 |
| Example 2 | 55 | 94 |
| Example 3 | 53 | 93 |
| Com. Ex. 1 | 48 | 89 |
| Com. Ex. 2 | 51 | 90 |
| Com. Ex. 3 | 49 | 88 |
| Com. Ex. 4 | 43 | 88 |

As can be clearly seen from Tables 1 to 3, the test cells of Examples 1 to 3, each of which included a negative electrode containing an appropriate amount of oxide particles having an appropriate average particle size of primary particles and low crystallinity, exhibited load characteristics and charge/discharge cycle characteristics superior to those of the test cell of Comparative Example 1, which included a negative electrode containing no oxide particles.

On the other hand, the test cell of Comparative Example 2, which used a negative electrode containing an excessive amount of oxide particles, exhibited the influence of a reduction in the electron conductivity resulting from mixing of the insulating particles, along with the effect obtained by the inclusion of oxide particles. Although the load characteristics were not deteriorated, the load characteristics improving effect of the test cell of Comparative Example 2 was inferior to those of the test cells of the examples. Among the test cells of Comparative Examples 3 and 4, each included a negative electrode containing oxide particles having a large average particle size of primary particles and high crystallinity, the test cell of Comparative Example 3, which used oxide particles with a relatively small particle size, exhibited load characteristics comparable to those of the test cell of Comparative Example 1, which did not use oxide particles. Further, the test cell of Comparative Example 4, which used coarser oxide particles, exhibited load characteristics inferior to those of the test cell of Comparative Example 1. Both of the test cells could not be expected to provide a significant increase in the load characteristics.

### Example 4

A negative electrode was produced in the same manner as in Example 1 except that the thickness of the negative electrode material mixture layer was changed to 91 μm. That is, the oxide particles used for the negative electrode material mixture layer of this negative electrode was the same as those used for the negative electrode of the battery of Example 1, and the ratio of the oxide particles with respect to 100 mass % of the total of the negative electrode active material particles and the oxide particles in this negative electrode was also the same as that in the negative electrode of the battery of Example 1. Further, the dispersed particle size of the oxide particles (ZrO₂.5H₂O) in the negative electrode material mixture layer of this negative electrode measured by the above-described method was 134 nm.

Further, a positive electrode was produced in the same manner as in Example 1 except that the positive electrode material mixture-containing composition was applied such that the amount of the spinel manganese serving as the active material and contained in the positive electrode was 30 mg/cm² and dried, thus changing the thickness of the positive electrode material mixture layer to 100 μm.

Then, a test cell was produced in the same manner as in Example 1 except that the above-described negative electrode and positive electrode were used.

### Comparative Example 5

A negative electrode was produced in the same manner as in Comparative Example 3 except that the thickness of the negative electrode material mixture layer was changed to 91 μm. That is, the oxide particles used for the negative electrode material mixture layer of this negative electrode was the same as those used for the negative electrode of the battery of Comparative Example 3, and the ratio of the oxide particles with respect to 100 mass % of the total of the negative electrode active material particles and the oxide particles in this negative electrode was also the same as that in the negative electrode of the battery of Comparative Example 3. Further, the dispersed particle size of the oxide particles (ZrO₂) in the negative electrode material mixture layer of this negative electrode measured by the above-described method was 93 nm.

Further, a positive electrode was produced in the same manner as in Example 1 except that the positive electrode material mixture-containing composition was applied such that the amount of the spinel manganese serving as the active material and contained in the positive electrode was 30 mg/cm² and dried, thus changing the thickness of the positive electrode material mixture layer to 100 μm.

Then, a test cell was produced in the same manner as in Comparative Example 3 except that the above-described negative electrode and positive electrode were used.

The load characteristics and the charge/discharge cycle characteristics of the test cells of Example 4 and Comparative Example 5 were evaluated in the same manner as with the test cell of Example 1 and the like. The results are shown in Table 4.

TABLE 4

| | Load | |
|---|---|---|
| | characteristics | Charge/discharge cycle |
| | Capacity | characteristics |
| | retention rate | Capacity retention rate |
| | (%) | (%) |
| Example 4 | 47 | 76 |
| Com. Ex. 5 | 27 | 59 |

It is generally known that increasing the thickness of the electrode material mixture layer of the electrode of the lithium ion secondary battery leads to a reduction in the overall utilization efficiency of the active material as described above and therefore the load characteristics of the battery is lower than in the case where the thickness of the electrode material mixture layer is small. However, the test cell of Example 4, which included a negative electrode containing an appropriate amount of oxide particles having an appropriate average particle size of primary particles and low crystallinity, exhibited load characteristics superior to those of the test cell of Comparative Example 5, which included a negative electrode containing oxide particles having a large average particle size of primary particles and low crystallinity. From these results, it can be confirmed that the electrode of the present invention that contains an appropriate amount of oxide particles having an appropriate average particle size of primary particles and low crystallinity can enhance the load characteristics of a battery (the battery of the present invention) that uses the electrode of the present invention even in the case where the thickness of the electrode material mixture layer is increased.

### Example 5

A negative electrode material mixture-containing composition was produced in the same manner as in Example 1 except that 94 parts by mass of flake graphite and 4 parts by mass of a composite of SiOₚ whose surface was coated with carbon (carbon formed by the CVD method) (the mass ratio of SiOₚ and the carbon on the surface: 85:15, the average particle size: 5 μm, hereinafter, referred to as “SiOₚ—C composite) were used as the negative electrode active material in place of 98 parts by mass of flake graphite in the production method for the lithium ion secondary battery in Example 1. Thereafter, a negative electrode was produced in the same manner as in Example 1 except that this negative electrode material mixture-containing composition was applied to one side of a copper foil such that the amount of the negative electrode material mixture applied was 12.5 mg/cm², dried and then pressed, thus changing the thickness of the negative electrode material mixture layer to 79 μm.

In conformity to this, 94 parts by mass of Li_{1.02}Ni_{0.5}Mn_{0.2}CO_{0.3}O₃ serving as the positive electrode active material, 4 parts by mass of acetylene black serving as the conductivity enhancing agent, and 2 parts by mass of PVDF serving as the resin binder were added to NMP, then mixed and dispersed, to produce a positive electrode material mixture-containing composition. Thereafter, a positive electrode was produced in the same manner as in Example 1 except that this positive electrode material mixture-containing composition was applied to one side of an aluminum foil such that the amount of the positive electrode material mixture applied was 31 mg/cm², dried and then pressed, thus changing the thickness of the positive electrode material mixture layer to 112 μm.

Then, a test cell was produced in the same manner as in Example 1 except that the above-described negative electrode and positive electrode were used.

### Comparative Example 6

A test cell was produced in the same manner as in Example 5 except that the zirconium oxide particles used in Comparative Example 3 were used in place of the hydrated zirconium oxide particles in the production method for the lithium ion secondary battery of Example 5.

The load characteristics and the charge/discharge cycle characteristics of the test cells of Example 5 and Comparative Example 6 were evaluated in the same manner as with the test cell of Example 1 and the like. The results are shown in Table 5.

TABLE 5

| | Load | |
|---|---|---|
| | characteristics | Charge/discharge cycle |
| | Capacity | characteristics |
| | retention rate | Capacity retention rate |
| | (%) | (%) |
| Example 5 | 65 | 69 |
| Com. Ex. 6 | 46 | 52 |

Also in the case of using the negative electrode active material containing the SiOₚ—C composite, the test cell of Example 5, which included a negative electrode containing an appropriate amount of oxide particles having an appropriate average particle size of primary particles and low crystallinity, exhibited load characteristics superior to those of the test cell of Comparative Example 6, which included a negative electrode containing oxide particles having a large average particle size of primary particles and high crystallinity.

### Examples of Cylindrical Lithium Ion Secondary Battery

### Example 6

Production of Negative Electrode

The same hydrated zirconium oxide particles as those produced in Example 1 were added to water in an amount to give 20 mass %, and mixed in a paint shaker for one hour using zirconia beads with a diameter of 0.3 mm, to prepare an aqueous dispersion of the hydrated zirconium oxide particles. As the result of the SEM observation of 100 pieces of the hydrated zirconium oxide particles in the aqueous dispersion, the largest diameter of the dispersed particles was 116 nm.

98 parts by mass of artificial graphite serving as the negative electrode active material, 1 part by mass of SBR serving as the resin binder, and 1 part by mass of CMC were dispersed in water to prepare a dispersion. Further, the aqueous dispersion of the hydrated zirconium oxide particles were added to this dispersion such that the ratio of the hydrated zirconium oxide particles was 1 mass % with respect to 100 mass % of the total of the hydrated zirconium oxide particles and artificial graphite, and mixed in a paint shaker for about 15 minutes without using dispersing beads, to prepare a negative electrode material mixture-containing composition.

Next, the negative electrode material mixture-containing composition was uniformly applied to both sides of a negative electrode current collector made of a 10 μm-thick copper foil, dried and then compression-molded with a roll pressing machine to have a total thickness of 138 μm (the thickness per side of the negative electrode material mixture layer: 64 μm), followed by cutting, to produce a band-shaped negative electrode. Further, the dispersed particle size of the hydrated zirconium oxide particles in the negative electrode material mixture layer determined by the above-described method was 134 nm.

### Production of Positive Electrode

3 parts by mass of acetylene black serving as the conductivity enhancing agent were added to 94 parts by mass off Li_{1.02}Ni_{1/3}l Mn_{1/3}Co_{1/3}O₂, which is a layer-structured lithium-containing composite oxide, serving as the positive electrode active material, and mixed. To the resulting mixture, a solution in which 3 parts by mass of PVDF serving as the resin binder were dissolved in NMP was added, mixed, and dispersed to prepare a positive electrode material mixture-containing composition.

Next, the positive electrode material mixture-containing composition was uniformly applied to both sides of a positive electrode current collector made of a 15 μm-thick aluminum foil, dried and then compression-molded with a roll pressing machine to have a total thickness of 136 μm (the thickness per side of the positive electrode material mixture layer: 60.5 μm), followed by cutting, to produce a band-shaped positive electrode.

### Preparation of Non-Aqueous Electrolyte

LiPF₆ was dissolved at a concentration of 1.2 moll in a mixed solvent in which ethylene carbonate (EC) and diethyl carbonate (DEC) were mixed at a volume ratio of 30:70, to prepare a non-aqueous electrolyte.

### Production of Lithium Ion Secondary Battery

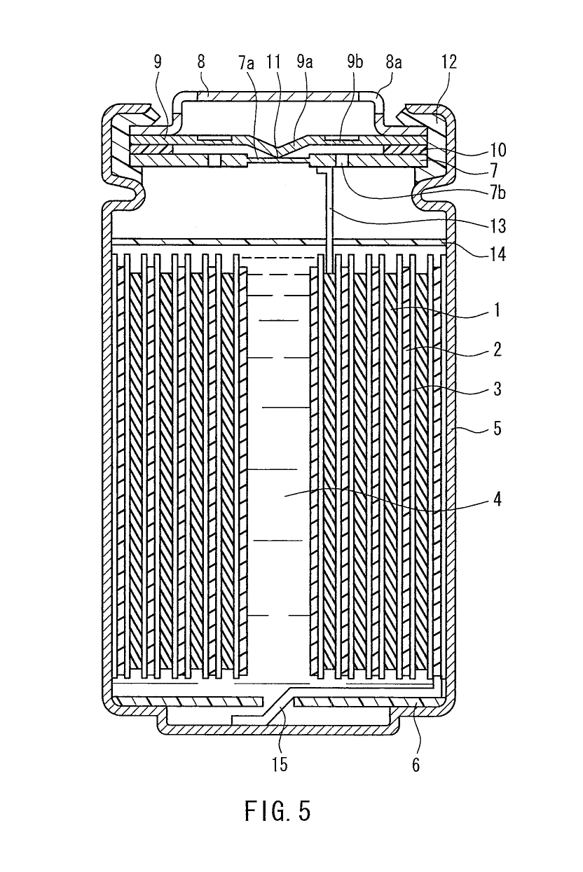

The band-shaped positive electrode was placed on the band-shaped negative electrode with a 16 μm-thick microporous polyethylene separator (porosity: 41%) disposed therebetween, and all were wound in a spiral fashion to form a wound electrode assembly. This wound electrode assembly was inserted into a cylindrical battery case. After the non-aqueous electrolyte was injected into the battery case, the battery case was sealed to produce a lithium ion secondary battery having a configuration as shown in FIG. 5. Note that the design electric capacity of the lithium ion secondary battery of this example when the battery was charged to 4.4 V was about 820 mAh.

Here, the battery shown in FIG. 5 will be described. In the lithium ion secondary battery shown in FIG. 5, a positive electrode 1 and a negative electrode 2 are wound in a spiral fashion with a separator 3 disposed therebetween, and these components are housed as a wound electrode assembly in a battery case 5 together with a non-aqueous electrolyte 4. Note that current collectors and the like that were used to produce the positive electrode 1 and the negative electrode 2 are not shown in FIG. 5 to avoid complexity.

The battery case 5 is made of stainless steel, and an insulator 6 made of PP has been placed at the bottom of the battery case 5 before insertion of the wound electrode assembly. A sealing plate 7 is made of aluminum and has the shape of a disc. The sealing plate 7 is provided with a thinned section 7a at its central portion, and is also provided, at the periphery of the thinned section 7a, a hole serving as a pressure inlet 7b for allowing the internal pressure of the battery to be exerted on an explosion-proof valve 9. Also, a projecting portion 9a of the explosion-proof valve 9 is welded to the top surface of the thinned section 7a, thus forming a weld portion 11. To facilitate the understanding of the drawing, the thinned section 7a provided in the sealing plate 7, the projecting portion 9a of the explosion-proof valve 9, and the like are shown only in section, and illustration of the outline behind the section is omitted. Also, the weld portion 11 of the thinned section 7a of the sealing plate 7 and the projecting portion 9a of the explosion-proof valve 9 are illustrated in an exaggerated manner to facilitate understanding of the drawing.

A terminal plate 8 is made of rolled steel, is plated with nickel on the surface, and has the shape of a hat having a flange-shaped peripheral portion. The terminal plate 8 is provided with a gas outlet 8a. The explosion-proof valve 9 is made of aluminum and has the shape of a disc. The explosion-proof valve 9 is provided, at its central portion, the projecting portion 9a having a tip portion on the power generating element side (the lower side in FIG. 5) and is also provided with a thinned section 9b. As described above, the bottom surface of the projecting portion 9a is welded to the top surface of the thinned section 7a of the sealing plate 7, thus forming the weld portion 11. A ring-shaped insulating packing 10 made of PP is disposed above the peripheral portion of the sealing plate 7. The explosion-proof valve 9 is disposed above the insulating packing 10, and provides insulation between the sealing plate 7 and the explosion-proof valve 9, while sealing the gap between the sealing plate 7 and the explosion-proof valve 9 so as to prevent leakage of the non-aqueous electrolyte from the space therebetween. A ring-shaped gasket 12 is made of PP. A lead member 13 is made of aluminum, and connects the sealing plate 7 to the positive electrode 1. An insulator 14 is disposed above the wound electrode assembly, and the negative electrode 2 and the bottom of the battery case 5 were connected by a lead member 15 made of nickel.

In this battery, the thinned section 7a of the sealing plate 7 and the projecting portion 9a of the explosion-proof valve 9 are in contact at the weld portion 11, the peripheral portion of the explosion-proof valve 9 and the peripheral portion of the terminal plate 8 are in contact, and the positive electrode 1 and the sealing plate 7 are connected by the lead member 13 on the positive electrode side. Accordingly, in an ordinary state, the positive electrode 1 and the terminal plate 8 are electrically connected by the lead member 13, the sealing plate 7, the explosion-proof valve 9, and the weld portion 11 of the sealing plate 7 and the explosion-proof valve 9, and thus normally operate as an electric circuit.

In the case where an abnormal state occurs in the battery; for example, when the battery is exposed to high temperatures, and the internal pressure of the battery is increased due to a gas generated inside the battery; such an increase in the internal pressure causes the central portion of the explosion-proof valve 9 to be deformed in the direction of the internal pressure (upward in FIG. 5). As a result, shearing force is exerted on the thinned section 7a, which is integrated with the explosion-proof valve 9 at the weld portion 11, and the thinned section 7a is broken, or the weld portion 11 of the projecting portion 9a of the explosion-proof valve 9 and the thinned section 7a of the sealing plate 7 is detached. Thereafter, the thinned section 9b provided in the explosion-proof valve 9 ruptures to release the gas from the gas outlet 8a of the terminal plate 8 to the outside of the battery, and thereby the battery is designed to be prevented from explosion.

### Example 7

A negative electrode was produced in the same manner as in Example 6 except that the same cerium chloride particles as those produced in Example 2 were used in place of the hydrated zirconium oxide particles, and a lithium ion secondary battery was produced in the same manner as in Example 6 except that this negative electrode was used. Further, the dispersed particle size of the cerium chloride particles in the negative electrode material mixture layer determined by the above-described method was 76 nm.

### Example 8

A negative electrode was produced in the same manner as in Example 6 except that the same aluminum hydroxide particles as those produced in Example 3 were used in place of the hydrated zirconium oxide particles, and a lithium ion secondary battery was produced in the same manner as in Example 6 except that this negative electrode was used. Further, the dispersed particle size of the aluminum hydroxide particles in the negative electrode material mixture layer determined by the above-described method was 231 nm.

### Comparative Example 7

A negative electrode was produced in the same manner as in Example 6 except that the hydrated zirconium oxide particles were not used, and a lithium ion secondary battery was produced in the same manner as in Example 6 except that this negative electrode was used.

### Comparative Example 8

A lithium ion secondary battery was produced in the same manner as in Example 6 except that a negative electrode was produced by adjusting the negative electrode material mixture-containing composition such that the ratio of the hydrated zirconium oxide particles was 15 mass % with respect to 100 mass % of the total of the hydrated zirconium oxide particles and artificial graphite, and that this negative electrode was used. Further, the dispersed particle size of the hydrated zirconium oxide particles in the negative electrode material mixture layer determined by the above-described method was 154 nm.

### Comparative Example 9

A negative electrode was produced in the same manner as in Example 6 except that the same zirconium oxide particles as those produced in Comparative Example 3 were used in place of the hydrated zirconium oxide particles, and a lithium ion secondary battery was produced in the same manner as in Example 6 except that this negative electrode was used. Further, the dispersed particle size of the zirconium oxide particles in the negative electrode material mixture layer determined by the above-described method was 93 nm.

The load characteristics and the charge/discharge cycle characteristics of the test cells of Examples 6 to 8 and Comparative Examples 7 to 9 were evaluated by the following method.

### Evaluation of Load Characteristics

Each of the batteries of Examples 6 to 8 and Comparative Examples 7 to 9 was fully charged by constant current-constant voltage charging (end-of-charge voltage: 4.4 V) in which the battery was charged with 410 mA at 20° C. until the battery voltage reached 4.4 V and further charged with a constant voltage of 4.4 V for 3 hours.

Thereafter, each battery was discharged with 820 mA at 20° C. until the battery voltage reached 2.5 V to measure the discharge capacity, and the measured discharge capacity was used as the standard discharge capacity.

Furthermore, each battery was charged under the same charging condition as described above, and discharged with a current value of 4.1 A (corresponding to 5 C) until the battery voltage reached 2.5 V to measure the discharge capacity, and the measured discharge capacity was used as the high rate discharge capacity.

The ratio of the high rate discharge capacity to the standard discharge capacity (High rate discharge capacity/Standard discharge capacity) of each battery was determined in percentage for evaluation of load characteristics.

### Evaluation of Charge/Discharge Cycle Characteristics

Each of the batteries of Examples 6 to 8 and Comparative Examples 7 to 9 was fully charged by constant current-constant voltage charging (end-of-charge voltage: 4.4 V) in which the battery was charged with 410 mA at 20° C. until the battery voltage reached 4.4 V and further charged with a constant voltage of 4.4 V for 3 hours.

Thereafter, a charge/discharge cycle of discharging each battery with 820 mA at 20° C. until the battery voltage reached 2.5 V was repeated 100 times. The ratio of the discharge capacity at the 100th cycles to the discharge capacity at the 10th cycle (Discharge capacity at 100th cycle/Discharge capacity at 10th cycle) was determined in percentage for evaluation of the charge/discharge cycle characteristics.

### Reference Example

A battery having the same configuration as with Example 6 was charged by constant current-constant voltage charging (end-of-charge voltage: 4.2 V) in which the battery was charged with 410 mA at 20° C. until the battery voltage reached 4.2 V and further charged with a constant voltage of 4.2 V for 3 hours.

Thereafter, as the result of discharging the battery with 820 mA at 20° C. until the battery voltage reached 2.5 V and measuring the discharge capacity, the discharge capacity under the conventional charging condition (end-of-charge voltage: 4.2 V) was 731 mAh.

On the other hand, the standard discharge capacity of the battery of Example 6 was 827 mAh, and thus a capacity increase of about 13% was achieved by increasing the end-of-charge voltage from 4.2 V to 4.4 V.

Table 6 shows the ratio of the oxide particles with respect to 100 mass % of the total of the active material particles and the oxide particles (described as “Ratio” in Table 6) and the dispersed particle size of the oxide particles in the negative electrode material mixture layer (described as “Dispersed particle size in negative electrode material mixture layer” in Table 6) of each of the negative electrodes of the batteries of Examples 6 to 8 and Comparative Examples 7 to 9, and Table 7 shows the results of the above-described evaluations.

TABLE 6

Oxide particles

| | | Dispersed particle size |
|---|---|---|
| | | in negative electrode |
| | Ratio | material mixture layer |
| | (mass %) | (nm) |
| Example 6 | 1 | 134 |
| Example 7 | 1 | 76 |
| Example 8 | 1 | 231 |
| Com. Ex. 7 | 0 | — |
| Com. Ex. 8 | 15 | 154 |
| Com. Ex. 9 | 1 | 93 |

TABLE 7

| | Load | Charge/discharge cycle |
|---|---|---|
| | characteristics | characteristics |
| | (%) | (%) |
| Example 6 | 60 | 94 |
| Example 7 | 54 | 92 |
| Example 8 | 52 | 91 |
| Com. Ex. 7 | 46 | 71 |
| Com. Ex. 8 | 50 | 88 |
| Com. Ex. 9 | 48 | 82 |

As can be clearly seen from Table 7, the lithium ion secondary batteries of Examples 6 to 8, each of which used a negative electrode containing an appropriate amount of oxide particles having low crystallinity, separately from active material particles, exhibited load characteristics superior to those of the battery of Comparative Example 7, which used a negative electrode containing no oxide particles. Furthermore, in the lithium ion secondary batteries of Examples 6 to 8, the charge/discharge reaction in the electrode was made uniform, and variations in the utilization efficiency of the active material did not readily occur. Accordingly, excellent charge/discharge cycle characteristics were achieved even if charging was performed with a high voltage.

On the other hand, the battery of Comparative Example 8, which contained an excessive amount of oxide particles, exhibited the influence of a reduction in the electron conductivity resulting from mixing of the insulating particles, and the effect of improving the load characteristics and the charge/discharge cycle characteristics by addition of oxide particles was reduced. Further, in the case of the battery of Comparative Example 9, which used high crystalline oxide particles, the surface properties of the particles changed as compared to those of the low crystalline oxide particles, and the effect of improving the load characteristics and the charge/discharge cycle characteristics by addition of oxide particles was reduced.

The invention may be embodied in other forms without departing from the spirit or essential characteristics thereof. The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

What is claimed is:

1. An electrode for a lithium ion secondary battery, the electrode comprising an electrode material mixture layer containing oxide particles, active material particles capable of absorbing and desorbing Li, and a resin binder,
wherein the oxide particles have an average particle size of primary particles of 1 to 20 nm, and have no peak or have a width at half height of the highest intensity peak of 1.0° or more within the range of 2θ=20 to 70° in a powder X-ray diffraction spectrum, and
the ratio of the oxide particles is 0.1 to 10 mass % when the total of the active material particles and the oxide particles is taken as 100 mass %.

2. The electrode for a lithium ion secondary battery according to claim 1, wherein the width at half height of the highest intensity peak of the oxide particles is 1.5° or more.

3. The electrode for a lithium ion secondary battery according to claim 1, wherein the oxide particles have a specific surface area determined by nitrogen gas adsorption of 30 to 500 m²/g.

4. The electrode for a lithium ion secondary battery according to claim 1, wherein the oxide particles have a dispersed particle size of 300 nm or less in the electrode material mixture layer.

5. The electrode for a lithium ion secondary battery according to claim 1, wherein the oxide particles are particles of an oxide containing at least one element selected from the group consisting of Si, Zr, Al, Ce, Mg, Ti, Ba, and Sr.

6. The electrode for a lithium ion secondary battery according to claim 1, wherein the oxide particles are particles represented by ZrO₂.nH₂O where n=0.5 to 10, or particles represented by CeO₂ or Al(OH)₃.

7. The electrode for a lithium ion secondary battery according to claim 1, wherein the oxide particles have been obtained by an oxidation treatment in an aqueous solution.

8. The electrode for a lithium ion secondary battery according to claim 7, wherein the oxidation treatment in an aqueous solution is a hydrothermal treatment.

9. The electrode for a lithium ion secondary battery according to claim 8, wherein the oxide particles have been obtained by a hydrothermal treatment at 60 to 200° C. in a suspension with a pH of 4 to 11.

10. A lithium ion secondary battery comprising a positive electrode, a negative electrode, a non-aqueous electrolyte, and a separator,
wherein at least one electrode selected from the positive electrode and the negative electrode comprises an electrode material mixture layer containing oxide particles, active material particles capable of absorbing and desorbing Li, and a resin binder,
the oxide particles have an average particle size of primary particles of 1 to 20 nm, and have no peak or have a width at half height of the highest intensity peak of 1.0° or more within the range of 2θ=20 to 70° in a powder X-ray diffraction spectrum, and
the ratio of the oxide particles is 0.1 to 10 mass % when the total of the active material particles and the oxide particles is taken as 100 mass %.

11. The lithium ion secondary battery according to claim 10, wherein the width at half height of the highest intensity peak of the oxide particles is 1.5° or more.

12. The lithium ion secondary battery according to claim 10, wherein the oxide particles have a specific surface area determined by nitrogen gas adsorption of 30 to 500 m²/g.

13. The lithium ion secondary battery according to claim 10, wherein the oxide particles have a dispersed particle size of 300 nm or less in the electrode material mixture layer.

14. The lithium ion secondary battery according to claim 10, wherein the oxide particles are particles of an oxide containing at least one element selected from the group consisting of Si, Zr, Al, Ce, Mg, Ti, Ba, and Sr.

15. The lithium ion secondary battery according to claim 10, wherein the oxide particles are particles represented by ZrO₂.nH₂O where n=0.5 to 10, or particles represented by CeO₂ or Al(OH)₃.

16. The lithium ion secondary battery according to claim 10, wherein the oxide particles have been obtained by an oxidation treatment in an aqueous solution.

17. The lithium ion secondary battery according to claim 16, wherein the oxidation treatment in an aqueous solution is a hydrothermal treatment.

18. The lithium ion secondary battery according to claim 17, wherein the oxide particles have been obtained by a hydrothermal treatment at 60 to 200° C. in a suspension with a pH of 4 to 11.

19. The lithium ion secondary battery according to claim 10, wherein the end-of-charge voltage is set within the range from 4.3 to 4.6 V.
